(19) United States
(12) Patent Application Publication
(10) Pub. No.: US 2006/0168084 A1
(43) Pub. Date: Jul. 27, 2006

(54) Method and apparatus for rendering load balancing and failover

(76) Inventors: Leonid Kogan, Yokne'Am Ilt (IL); Andrey Varshavsky, Nesher (IL); Yanki Margalit, Ramat Gan (IL); Dany Margalit, Ramat Gan (IL)

Correspondence Address: DR. MARK FRIEDMAN LTD.;c/o Bill Polkinghorn, 9003 Florin Way, Upper Marlboro, MD, 20772, US

(21) Appl. No.: 11/286,347

(22) Filed: Nov. 25, 2005

Related U.S. Application Data
(60) Provisional application No. 60/631,151, filed on Nov. 29, 2004.

(51) Int. Cl. G06F 15/16

(52) U.S. Cl. 709/207

(57) ABSTRACT

In one aspect, the present invention is directed to a method for balancing a load on a cluster providing a service and failing over ceasing a server of the cluster, the method comprising the steps of: for each of the servers of a cluster: broadcasting a heartbeat (e.g. according to the ARP protocol); indicating the availability of each of the other servers of the cluster according to the heartbeats received from the other servers; and determining if the server is the master according to a predefined rule which all the available servers are familiar with. Then, the master divides the activity for providing the service among the available servers of the cluster.

This application claims priority from U.S. Provisional Application Ser. No. 60/431,151 filed Nov. 29, 2004.

### FIELD OF THE INVENTION

The present invention relates to the field of load-sharing and fail-over. More particularly, the invention relates to a method and system for rendering load-sharing and fail-over in local area networks.

### BACKGROUND OF THE INVENTION

The term “Server” refers herein to a computerized device for providing a service, which is able to communicate with another computerized device through a data communication channel.

The term “Load Balancing” refers in the art to a technique for spreading processing activity over a plurality of servers (i.e. service providers, such as computers, disks, etc). The plurality of servers refers in the art as “Cluster”. Load balancing is, for example, important for busy Web sites, which have to employ a plurality of Web servers. For example, when one of the Web servers gets swamped, requests to this server are forwarded to another server. Load balancing can also refer to the communications channels themselves. Load balancing systems employ an algorithm to determine how the requests for a service are spread over the servers of the cluster.

Some methods for rendering load balancing are known in the art. For example, “balancing methods”, in which the load on each server of a cluster is taken in to account in order to balance the load on the servers of a cluster; and “sharing methods”, in which the service tasks are shared arbitrary between the servers of a cluster, and more.

The term “Failover” refers herein to automatically overcoming on a situation where one or more of the servers of a cluster cease to provide its services. This provides to the load balancing system continuous availability and reliability.

It is an object of the present invention to provide a method and system for load balancing of a service.

It is a further object of the present invention to provide a method and system for failing over a fall of the servers of a cluster.

Other objects and advantages of the invention will become apparent as the description proceeds.

### SUMMARY OF THE INVENTION

In one aspect, the present invention is directed to a method for balancing a load on a cluster providing a service and failing over ceasing a server of the cluster, the method comprising the steps of: for each of the servers of a cluster: broadcasting a heartbeat; indicating the availability of each of the other servers of the cluster according to heartbeats received from the other servers; and determining if the server is the master according to a predefined rule which all the available servers are familiar with. Then, the master divides the activity for providing the service among the available servers of the cluster.

The rule may be: the master is the server, of the available servers of the cluster, that has the lowest IP address; the master is the server, of the available servers of the cluster, that has the highest IP address; the master is the server, of the available servers of the cluster, that has the lowest MAC; the master is the server, of the available servers of the cluster, that has the highest MAC; the master is the server, of the available servers of the cluster, that is first in a table of the available servers; the master is the server, of the available servers of the cluster, that is last in a table of the available servers; the master is the server, of the available servers of the cluster, that is selected according to a pseudo-random generator; and so forth.

The broadcasting is carried out periodically or occasionally.

According to a preferred embodiment of the invention the broadcasting is according to a protocol, e.g. ARP, UDP, ICMP, a protocol based on layer 2 frame of the OSI Model, and so forth.

The service may be a network service, a network service provided over OSI Model layers 3 through 7, a layer built on top of OSI Model layer 7, a virus inspection service, a spyware detection and blocking service, a spam filtering service, a content filtering service, and so forth.

According to one embodiment of the invention, the service is provided at a point in a data communication path, e.g. a gateway to a network.

### BRIEF DESCRIPTION OF THE DRAWINGS

The present invention may be better understood in conjunction with the following figures:

FIG. 1 schematically illustrates a load balancing network topology, according to a preferred embodiment of the invention.

FIGS. 2a and 2b are flowcharts of a method for rendering load balancing and failover, according to a preferred embodiment of the invention.

FIG. 2a is a flowchart of a process for determining the available servers of a cluster and the master of the cluster, according to a preferred embodiment of the invention.

FIG. 2b is a flowchart of a process that is carried out periodically, e.g. each N seconds.

FIG. 3 schematically illustrates the operation of a cluster, according to a preferred embodiment of the invention.

### DETAILED DESCRIPTION OF PREFERRED EMBODIMENTS

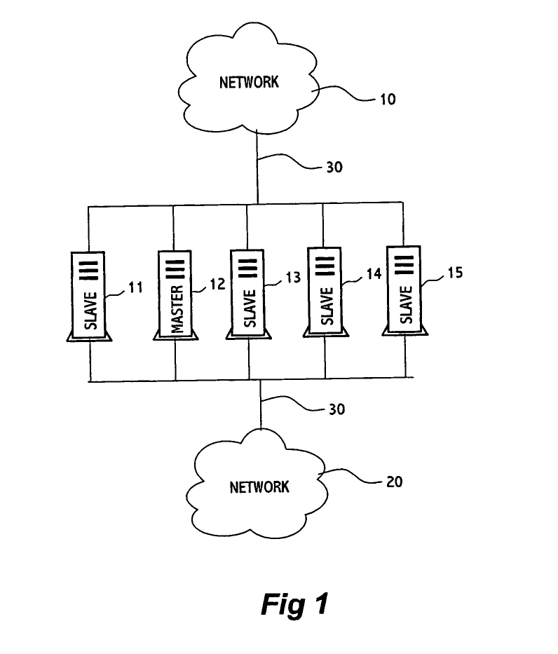

FIG. 1 schematically illustrates a load balancing network topology, according to a preferred embodiment of the invention. Network 10 communicates with network 20 via a communication channel 30. A cluster comprising servers 11 to 15 provide a service, such as virus inspection of packets transferred between network 10 and network 20.

According to the present invention, a cluster works as a single unit. The cluster enables distribution of traffic load over a number of servers, instead of a single server, and consequently the total throughput of the system (such as traffic speed while inspecting the packets transferred between network 10 and 20) is increased.

In the event that one of the servers in the cluster falls, the failover capability prevents downtime by enabling the other servers in the cluster to provide their service (e.g., inspect the traffic for viruses) instead. In a similar fashion, in high-capacity networks, the cluster enables distribution of the traffic load over a number of servers (instead of a single server only), and in this way increases total throughput.

The term “Heartbeat” refers herein to a data entity “broadcasted” (i.e. sent to the network in contrast to sending to a specific destination) by a device connected to the network. The purpose of a heartbeat is to inform other devices connected to the network about the status of the broadcasting device. For example, a device may broadcast a status which informs that the broadcasting device is functioning and available. The broadcasting may be carried out periodically or occasionally.

From the implementation point of view, heartbeat packets can be used as transportation means for a datagram style protocol (ARP, UDP, etc.). Heartbeats can be used also as a proprietary datagram protocol based on Ethernet frame format.

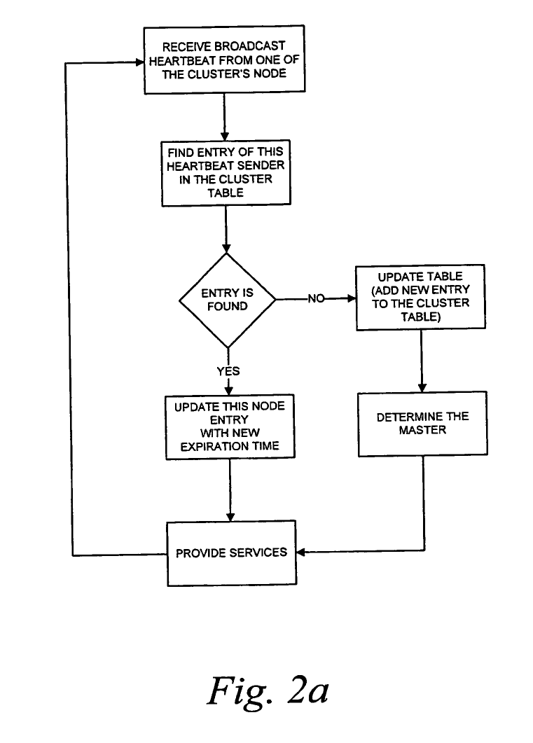

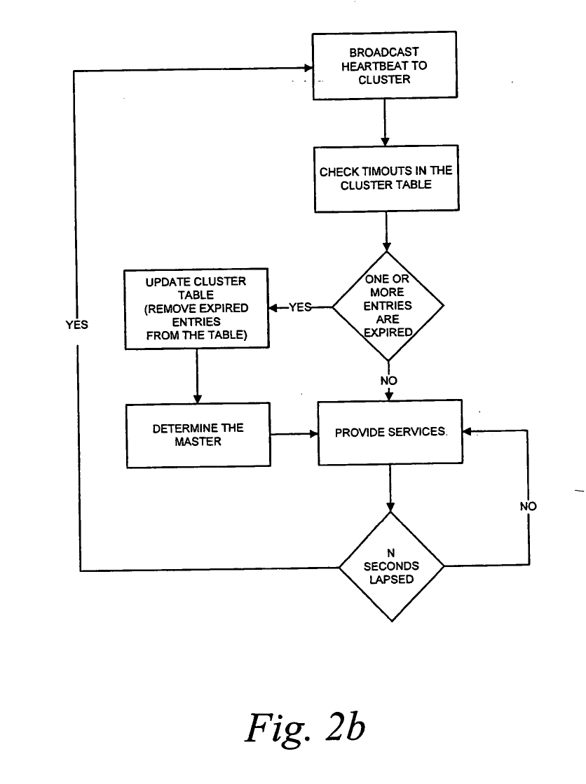

FIGS. 2a and 2b are flowcharts of a method for rendering load balancing and failover, according to a preferred embodiment of the invention.

FIG. 2a is a flowchart of a process for determining the available servers of a cluster and the master of the cluster, according to a preferred embodiment of the invention.

Each server of the cluster maintains a “Cluster Table”, where the details of the servers of a cluster are stored. A record of a server in the table is referred herein as Node Entry.

The first step is searching a corresponding Node Entry (in the Cluster Table) that has sent the heartbeat. If such an entry is found, then the “expiration time” of the server is updated in the found entry of the table. For example, if during 15 seconds from this moment no new heartbeat is received for this server, it means that the server has ceased.

However, if the Node Entry doesn't exist in the Cluster Table it means that a new server has been added to the cluster. In this case a new Node Entry is added to the Cluster Table, and the relevant details, such as its IP address in the network, are registered in the table.

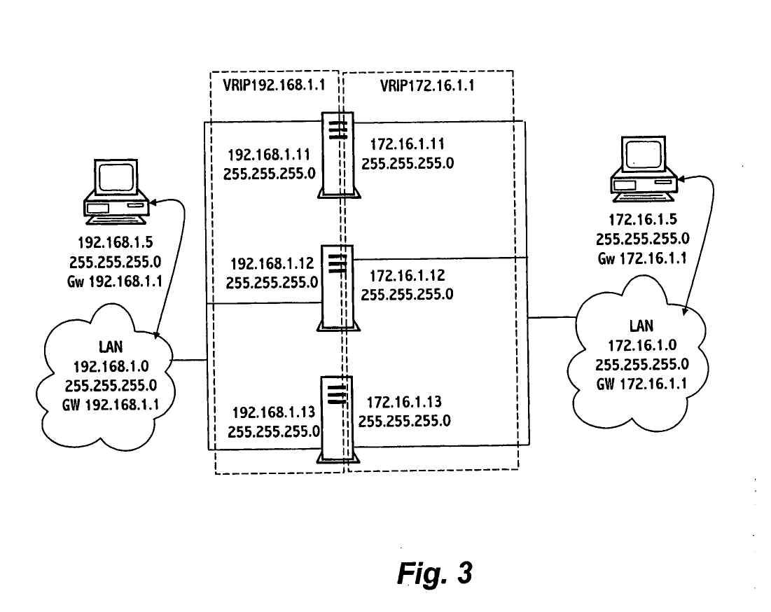

The next step is determining which server of the table is the master. The master is determined according to some predetermined rule, e.g. the server of the cluster which has the lowest IP address, etc. For example, referring to FIG. 3, the server with the lowest IP address 172.16.1.11.

After the master server has been determined, the master server runs a load balancing algorithm that determines which server of the cluster handles a received packet, etc.

It should be noted that this process is carried out by all the servers of a cluster, but after the master has been determined, only the master is in charge of routing the incoming traffic to the servers of the cluster such that the load on the servers will be balanced.

Since the master is actually one of the servers of the cluster, it can perform both, the “master” role, i.e. rerouting incoming traffic to the servers such that the load on the servers will be balanced, and the “slave” role, i.e. providing the service that the rest of the servers the cluster perform, e.g. virus inspection.

FIG. 2b is a flowchart of a process that is carried out periodically, e.g. each N seconds. At the beginning, each server of a cluster broadcasts a heartbeat to the rest of the servers of the cluster. In addition, the entries of the Node Entries of the Cluster Table are check for time expiration. Expired Node Entries are removed from the Cluster Table, and afterwards the master is determined the same way as described in FIG. 2a.

It should be noted that in both cases, the one described in FIG. 2a and the one described in FIG. 2b, each node continues to provide its services.

The master is the one that determines which server will handle a specific packet. In order to balance the load among the available servers of the cluster, the master executes a load balancing algorithm (load sharing algorithm, and so forth).

It should be noted that the master also may provide the service. Actually the only difference between the master and the other servers of a cluster is that the master is the one that decides to which server to reroute a packet. Thus, the master itself can be also a service provider. This way the need of a dedicated master is spared.

When the N seconds lapse, the process of determining the available servers, the master, etc. repeats.

FIG. 3 schematically illustrates the operation of a cluster, according to a preferred embodiment of the invention.

The operation is based on the following core principles:
1. All the servers of a cluster should be configured as IP routers for all subnets the cluster provides services for.
2. Each server of the cluster should have a unique IP address for each subnet it is connected for.
3. Routing rules should be the same for all the servers of a cluster.
4. All the servers should be physically connected to all subnets the cluster provides services to.

All the servers in the cluster have to share the same IP address per each subnet the cluster provides services for. This IP address so called virtual is assigned to each of the servers of the cluster. This Virtual IP (VIP) is in addition to the physical IP address of the servers of a cluster.

For example, if the cluster is connected to two subnets (referring to FIG. 3 for example: 192.168.1.0/255.255.255.0 and 172.16.1.0/255.255.255.0) it should provide two VIPs—one per subnet (For example, VIP 192.168.1.1 and VIP 172.16.1.1 respectively).

FIG. 3 illustrates the IP addresses of a cluster with regard to the subnets it is connected to, according to a preferred embodiment of the invention.

The IP addresses ranges of subnets are:
192.168.1.0-192.168.1.255, masked by 255.255.255.0; and
172.16.1.0-172.16.1.255, masked by 255.255.255.0.

The VIP of a subnet acts as the default gateway or the leading routing IP address. Thus, traffic is routed to the VIP, instead of the physical IP addresses of the cluster servers.

One of the servers of a cluster operates as the “master” of the cluster. Only the master represents VIP to the subnet this VIP belongs. It functions as a dispatcher, and employs a load balance method in order to “divide” the load among all the servers in the cluster, including the master itself. A load balancing (or load sharing) method is used to determine how to divide the traffic between the servers of the cluster.

All the servers in the cluster are configured with the same network configuration (subnets, default gateways, routers info, etc). Thus, the “slaves” send outgoing traffic to the external network by themselves.

When a server in a network attempts to communicate with the default gateway (Virtual IP address), it reaches to the master server of the cluster, i.e. the server with the highest IP address (or the lowest IP address, or any other arrangement, as specified herein). Depending on the number of active servers in the cluster, the master server will reroute the traffic to the next available cluster member. This is done by changing the packet's destination MAC address.

The lowest IP address, highest IP address are examples for a rule for determining the master from among the active servers of a cluster. Actually any unique identification number (string, value, etc.) associated with a server can be used for the same purpose. For example, the MAC of a server can be used as well, since it is unique for any server. In addition, each sever can be provided with an arbitrary ID, which can be stored within the server's memory. The highest value or the lowest values are also examples. Instead of the highest or lowest value, one can determine a rule which is a pseudo-random selection of the master. As long as all the active servers of a cluster are familiar with the other active servers, and familiar with the rule, any rule for selecting a member of a plurality of members will do.

According to a preferred embodiment of the invention, each server of the cluster announces its presence to the other servers of the cluster by sending broadcast or multicast pulse packets (“heartbeats”). Thus, at each given moment each server in the cluster is aware to which servers of the cluster are functioning.

Those skilled in the art will appreciate that the invention can be embodied in other forms and ways, without losing the scope of the invention. The embodiments described herein should be considered as illustrative and not restrictive.

1. A method for balancing a load on a cluster providing a service and failing over ceasing a server of said cluster, the method comprising the steps of:
for each of the servers of a cluster:
broadcasting a heartbeat;
indicating the availability of each of the other servers of said cluster according to a heartbeat received from each said other servers; and
determining if said server is the master according to a predefined rule that is familiar to all the available servers; and
dividing, by the server thus determined to be the master, the activity for providing said service among the available servers of said cluster.
A method according to claim 1, wherein said rule is: the master is the server, of the available servers of the cluster that has the lowest IP address.

2. A method according to claim 1, wherein said rule is: the master is the server, of the available servers of the cluster that has the highest IP address.

3. A method according to claim 1, wherein said rule is: the master is the server, of the available servers of the cluster that has the lowest MAC.

4. A method according to claim 1, wherein said rule is: the master is the server, of the available servers of the cluster that has the highest MAC.

5. A method according to claim 1, wherein said rule is: the master is the server, of the available servers of the cluster that appears first in a table of the available servers.

6. A method according to claim 1, wherein said rule is: the master is the server, of the available servers of the cluster that appears last in a table of the available servers.

7. A method according to claim 1, wherein said rule is: the master is the server, of the available servers of the cluster that is selected according to a pseudo-random number generator.

8. A method according to claim 1, wherein said broadcasting is carried out periodically.

9. A method according to claim 1, wherein said broadcasting is carried out occasionally.

10. A method according to claim 1, wherein said broadcasting is according to a protocol.

11. A method according to claim 1 1, wherein said protocol is selected from the group comprising: ARP, UDP, ICMP, a protocol based on layer 2 frame of the OSI Model.

12. A method according to claim 1, wherein said service is selected from a group comprising: a network service, a network service provided over OSI Model layers 3 through 7, a layer built on top of OSI Model layer 7, a virus inspection service, a spyware detection and. blocking service, a spam filtering service, a content filtering service.

13. A method according to claim 1, wherein said service is provided at a point in a data communication path.

14. A method according to claim 14, wherein said point is a gateway to a network.
